(19) United States
(12) Patent Application Publication
(10) Pub. No.: US 2026/0212489 A1
(43) Pub. Date: Jul. 23, 2026

(54) METHOD AND APPARATUS WITH LOCAL DEFECT DETECTION TRAINING

(71) Applicant: SAMSUNG ELECTRONICS CO., LTD., Suwon-si (KR)

(72) Inventors: Chanho AHN, Suwon-si (KR); Kikyung KIM, Suwon-si (KR); Seungju HAN, Suwon-si (KR); Minji KIM, Suwon-si (KR); Juyoung SON, Suwon-si (KR); Sungjoo SUH, Suwon-si (KR); Jiho LEE, Suwon-si (KR)

(73) Assignee: SAMSUNG ELECTRONICS CO., LTD., Suwon-si (KR)

(21) Appl. No.: 19/422,605

(22) Filed: Dec. 17, 2025

(30) Foreign Application Priority Data
Jan. 17, 2025 (KR) 10-2025-0007613

(51) Int. Cl. G06T 7/00; G06F 11/00

(52) U.S. Cl. CPC G06T 7/001; G06F 11/00; G06T 2207/20081

(57) ABSTRACT

An electronic device including defect generating circuitry configured to generate a defect image based on defect information and a normal image, characteristic comparison circuitry configured to determine a validity of the defect image based on a difference value between outputs obtained by inputting the defect image into a first model trained to output a first value and a second model trained to output a second value, the second value being a same value as the first value responsive to the defect image being analyzed as the normal image, and defect detecting circuitry configured to train a defect detection model to detect defects in a subject image based on the defect image.

### CROSS-REFERENCE TO RELATED APPLICATION

This application claims priority to and the benefit of Korean Patent Application No. 10-2025-0007613 filed at the Korean Intellectual Property Office on Jan. 17, 2025, the entire contents of which are incorporated herein by reference.

### BACKGROUND OF THE INVENTION

### (a) Field of the Invention

The present disclosure relates to a method and apparatus with defect detection, and more particularly, to a device and method with local defect detection training based on defect information for finding a defect in an object based on an image of the object.

### (b) Description of the Related Art

An anomaly detection system is a system that finds images of defect objects based on images of normal objects, and an anomaly sensing system is a system capable of sensing specific defect areas in defect images (i.e., local defects).

The nature of semiconductor manufacturing products is that they are technology-intensive and have short life cycles. In the long term, anomaly detection algorithms that adapt to changing product situations are needed. However, it is difficult to define in advance every way in which a newly manufactured product may be defective (i.e., have localized defects).

Therefore, there is a desire for technology to detect defects, particularly local defects, based on expert opinions or defective cases of previously developed products.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

In a general aspect, here is provided an electronic device including defect generating circuitry configured to generate a defect image based on defect information and a normal image, characteristic comparison circuitry configured to determine a validity of the defect image based on a difference value between outputs obtained by inputting the defect image into a first model trained to output a first value and a second model trained to output a second value, the second value being a same value as the first value responsive to the defect image being analyzed as the normal image, and defect detecting circuitry configured to train a defect detection model to detect defects in a subject image based on the defect image.

The defect detecting circuitry may be configured to output a trained defect detection model based on training the model on one or more valid defect images.

The defect generating circuitry may be further configured to generate a local defect reflecting the defect information at a specific location based on the normal image, define an area of the defect image including the local defect as a defect area, and generate the defect image to include the defect area.

The characteristic comparison circuitry may be further configured to determine that the defect image includes a valid defect area responsive to the difference value being greater than a threshold value.

The characteristic comparison circuitry may be configured to calculate a loss function to cause the difference value to appear greater than the threshold value in the valid defect area and calculate the difference value to appear as 0 in remaining areas other than the valid defect area, and the characteristic comparison circuitry may determine the validity using the loss function.

The defect generating circuitry may be configured to train the defect detection model for the first model and the second model to respectively output the first value and the second value as different values responsive to detecting an area of the defect image containing the defect area.

A trained defect detection model from the defect detecting circuitry may be trained to determine the subject image as containing a defect responsive to a difference value between the first value and the second value being greater than a predetermined value.

In a general aspect, here is provided an electronic device including one or more processors including processing circuitry and a memory including one or more storage media storing instructions that, when executed individually or collectively by the one or more processors, cause the electronic device to generate a defect image based on defect information and a normal image, determine a validity of the defect image based on a difference value between outputs obtained by inputting the defect image into a first model trained to output a first value and a second model trained to output a second value, the second value being a same value as the first value responsive to the defect image being analyzed as the normal image, and train a defect detection model to detect defects in a subject image based on one or more valid defect images to provide a trained defect detection model.

The generating may include instructing an image generation model to create the defect image using defect information to create a local defect in the normal image.

The generating may include using an image processing device to modify the normal image with an image of a defect from a deformation image library at a localized region in the normal image.

The generating of the defect image may include generating a local defect reflecting the defect information at a localized region based on the normal image, defining an area of the defect image including the local defect as a defect area, and generating the defect image to include the defect area.

The training further may further include training the defect detection model for the first model and the second model to respectively output the first value and the second value as different values responsive to detecting an area of the defect image containing the defect area.

In a general aspect, here is provided a processor-implemented method including generating a defect image based on defect information and a normal image, determining a validity of the defect image based on a difference value between outputs obtained by inputting the defect image into a first model trained to output a first value and a second model trained to output a second value, the second value being a same value as the first value responsive to the defect image being analyzed as the normal image, and training a defect detection model to detect defects in a subject image based on the defect image.

The method may include providing a trained defect detection model based on training the model on one or more valid defect images.

The generating may further include generating a local defect reflecting the defect information at a specific location based on the normal image, defining an area of the defect image including the local defect as a defect area, and generating the defect image to include the defect area.

The determining may further include determining that the defect image includes a valid defect area responsive to the difference value being greater than a threshold value.

The determining may further include calculating a loss function to cause the difference value to appear greater than the threshold value in the valid defect area, calculating the difference value to appear as 0 in remaining areas other than the valid defect area, and determining the validity based on the loss function.

The training may further include training the defect detection model for the first model and the second model to respectively output the first value and the second value as different values responsive to detecting an area of the defect image containing the defect area.

A trained defect detection model from the training may be trained to determine whether the subject image contains a defect responsive to a difference value between the first value and the second value being greater than a predetermined value.

### BRIEF DESCRIPTION OF THE DRAWINGS

FIG. 1 illustrates an example system with defect detection of local defects based on defect information according to one or more embodiments.

FIG. 2 illustrates an example electronic device with defect detection of local defects based on defect information according to one or more embodiments.

FIG. 3 illustrates an example process of learning based on defect information according to one or more embodiments.

FIG. 4 illustrates an example process with defect detection of local defects device based on defect information according to one or more embodiments.

FIG. 5 illustrates an example method with defect detection of local defects device based on defect information according to one or more embodiments.

FIGS. 6 and 7 illustrate example methods with defect image generation according to one or more embodiments.

FIG. 8 illustrates an example effect according to one or more embodiments.

FIG. 9 illustrates an example electronic device according to one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used in connection with various example embodiments of the disclosure, any use of the terms “module” or “unit” means hardware and/or processing hardware configured to implement software and/or firmware to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

Hereinafter, embodiments of the present disclosure will be described in detail with reference to the accompanying drawings.

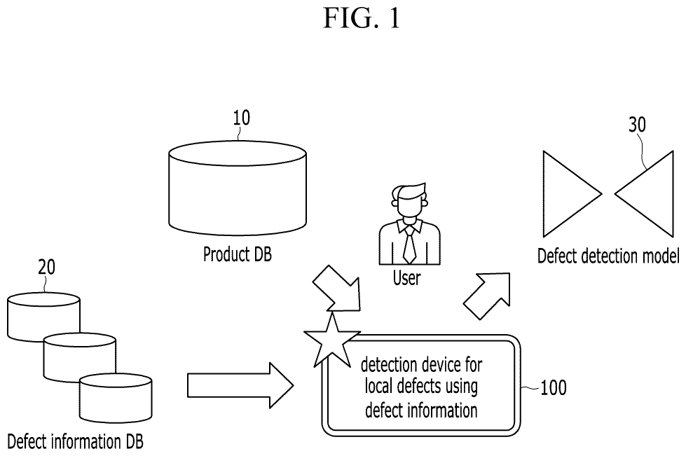

FIG. 1 illustrates an example system with defect detection of local defects based on defect information according to one or more embodiments.

Referring to FIG. 1, in a non-limiting example, a detection system for detecting local defects based on defect information 1 may include an electronic device with defect detection of local defects based on defect information 100, a product database (DB) 10, a defect information database 20, and a defect detection model 30. In addition, a user may interact with the detection system 1.

The product database 10 may include images including product images, such as a normal image (i.e., a defect free product) for a product (e.g., a semiconductor device). However, the type of the product here is not particularly limited to semiconductor devices.

The defect information database 20 may include defect information about defects that have previously occurred in the product being considered. The defect information database 20 may update defect information based on history information and user opinions about defects.

In an example, the defect detection model 30 may detect defects in an image being considered (i.e., a subject image). The considered or subject image may be retrieved from a database of images to be considered (e.g., product database 10). The image being considered may be input or provided to the model. For example, the defects may be local defects that are found within a particular area in the image of an object being considered. On the other hand, global defects maybe anomalies or defects that occur on a larger scale within the object being considered. For example, while global defects may be readily apparent, local defects may be more difficult to find.

In an example, the detection system 1, the electronic device 100 (i.e., a detection device for local defects which may use defect information) may train a defect detection model (e.g., the defect detection model 30) to detect defects in an image of a product. The image (e.g., a subject image) may be input or provided by a user through the product database 10 which may be provided to or retrieved by the defect detection model and/or circuitry. In addition, access to the defect detection model may be provided to the user for assessing the content of these subject images.

In an example, the electronic device 100 may collect defect information from the defect information database 20, generate a defect image including a defect area based on a normal image of an input product using the defect information, and train the defect detection model 30 based on the generated defect image.

In an example, the electronic device 100 may generate the defect detection model 30 which may detect the defect area based on defect information obtained from the defect information database 20 and the normal image based on the product database 10 for the input image. For example, the subject image may be input by the user.

That is, the user may continuously train the defect detection model 30 for a desired product based on the product database 10 and/or the defect information database 20. Therefore, the trained defect detection model 30 may be employed to defect detects in images of those products. Upon training, trained defect detection models (e.g., defect detection model 30) may be provided to users (e.g., a manufacturer) for the users to assess their products during manufacturing, for example.

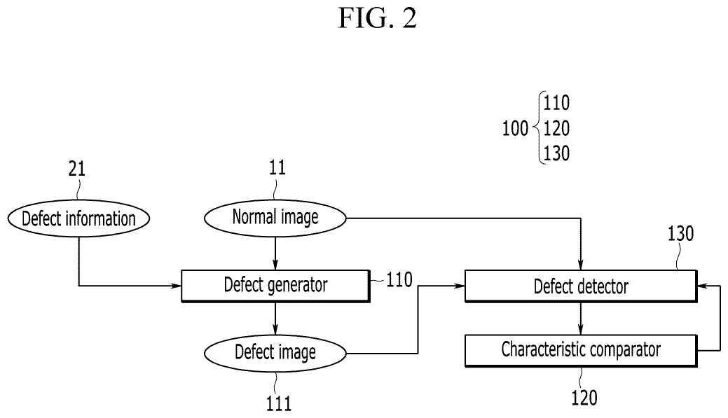

FIG. 2 illustrates an example electronic device with defect detection of local defects based on defect information according to one or more embodiments.

Referring to FIG. 2, in a non-limiting example, the electronic device 100 may execute program codes or instructions loaded into one or more memory devices through one or more processors.

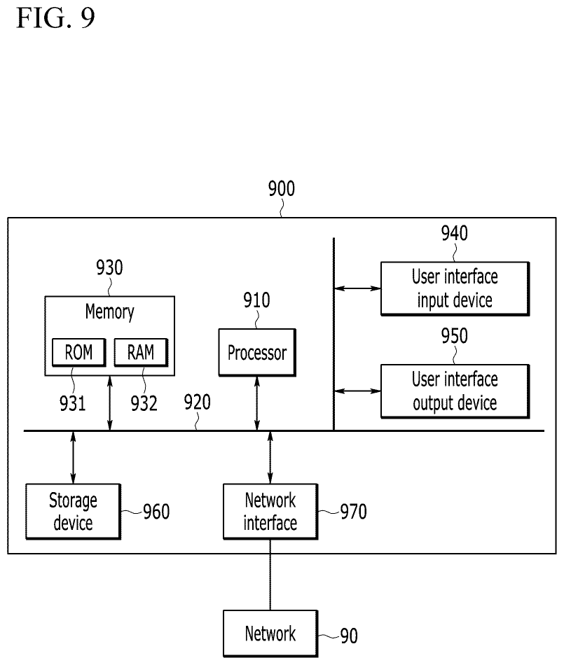

For example, the electronic device 100 may be implemented with a electronic apparatus 900 such as that described below with reference to FIG. 9. In this case, one or more processors may correspond to a processor 910 of the electronic apparatus 900, and one or more memory devices may correspond to a memory 930 of the electronic apparatus 900. Furthermore, some functions may be described as being performed by circuitry including one or more processing elements.

Program code or instructions may be executed by one or more processors to generate and provide a learned defect detection model based on the defect information to a user.

In an example, the electronic device 100 may include a defect generator 110 (e.g., defect generating circuitry), a characteristic comparator 120 (e.g., characteristic comparison circuitry), and a defect detector 130 (e.g., defect detecting circuitry).

In an example, the defect generator 110 may generate a defect image 111 based on input defect information 21 and a normal image 11.

T The defect image 111 may be generated using at least one of a generative artificial intelligence model and an image processing library. For example, the generated local defect may reflect the defect information 21 and be placed at a specific location or within a localized region based on the normal image 11. That is, the defect generator 110 may define an area that includes the local defect as a defect area, and generate the defect image 111 which includes the defect area. The defect area may be a local defect placed at a localized region or specific location.

In an example, the characteristic comparator 120 may determine the validity of the defect image 111 based on the difference value between the outputs obtained by inputting the defect image 111 into a first model and a second model where the second model is trained to output a same value as the first model for the normal image. That is, the second model may output that same value upon analyzing the received defect image and finding it to be a normal image (i.e., being consistent with images of products considered to be normal or non-defective). For example, the first model may be a state-of-the-art (SOTA) model and the second model may be a normal concentration model.

The characteristic comparator 120 may determine the defect image 111 to include a valid defect area in an instance in which a comparison results in a difference value being greater than a threshold value as a valid defect image. A loss function may be calculated such that the loss function causes the difference value between outputs to appear greater than the threshold value only in the valid defect area and the difference value to appear as 0 in the remaining areas, and may determine validity using the loss function. That is, the characteristic comparator 120 may highlight the valid defect area.

In an example, the defect detector 130 may train a defect detection model (e.g., the defect detection model 30) to detect the defect in the input image based on the defect image with one or more defect images (e.g., the defect image 111) when the defect images are determined to be valid. Upon completion of the training of the defect detection model with valid defect images, the trained defect detection model may be output. For example, a user (e.g., a manufacturer or processing facility) may be provided with a trained defect detection model for that user's products upon validation (i.e., the model can correctly detect local defects in those products).

The defect detector 130 may train the defect detection model so that the SOTA model (i.e., the first model) and the normal concentration model (i.e., the second model) output different values for the defect area. The defect detection model may determine that the input image as having the defect when a first output value through the SOTA model and a second output value through the normal concentration model differ from each other by a predetermined amount.

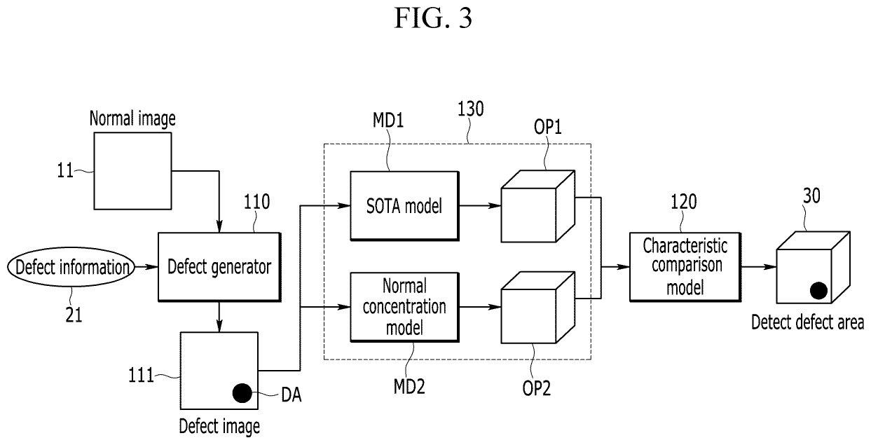

FIG. 3 illustrates an example process of learning based on defect information according to one or more embodiments.

Referring to FIG. 3, in a non-limiting example, the defect generator 110 may generate the defect image 111 including a defect area DA based on the normal image 11 and the defect information 21.

The defect detector 130 may learn and generate the defect detection model 30 based on the defect image 111.

The defect detector 130 may include a SOTA model MD1 (i.e., the first model) and a normal concentration model MD2 (i.e., the second model). The defect detector 130 may determine that a defect is present in the input image when a first output OP1 through the SOTA model MD1 and the second output OP2 through the normal concentration model MD2 differ from each other for the input image.

The SOTA (state of the art) model MD1 may be a model trained on the same image or different images. In an example, the SOTA model MD1 may be a model with guaranteed general performance. In other words, the SOTA model MD1 may correspond to the artificial intelligence model that achieved a high reported performance for a specific point in time for a specific problem or task. As a high performing mode, the SOTA model MD1 may be selected from among available models as a model that has demonstrated the best (or otherwise high) performance among similar models when compared with quantitative indicators (e.g., accuracy, F1 score). For example, the SOTA model MD1 may include a you-only-look-once (YOLO) model, ResUNet, vision transformer (ViT), or a diffusion model.

On the other hand, the normal concentration model MD2 may be a model trained to produce a same output as the SOTA model MD1 for images of normal products. That is, the normal concentration model MD2 may be a model trained to output a same value as the SOTA model MD1 only for normal images of normal products.

Here, training to output the same value may refer to training to output exactly the same value or training to output the same level of value within a predetermined error range. Therefore, the variance of the output values of the normal concentration model MD2 may be large when the input image includes untrained anomalies or defects. That is, the normal concentration model MD2 does not output the same value (i.e., compared to the SOTA model MD 1) for an image with an anomaly or defect (i.e., an anomalous image or the defect image 111).

The defect detector 130 may detect the defect area DA included in the defect image 111 and train the normal concentration model MD2 to generate the second output OP2 different from the first output OP1 of the SOTA model MD1 for the corresponding defect area DA.

The characteristic comparator 120 may determine the validity of the defect image 111. That is, the characteristic comparator 120 may determine an image to be valid (i.e., as a valid defect image) when a defect image including a defect area in which the difference value between the first output OP1 of the SOTA model MD1 and the second output OP2 of the normal concentration model MD2 is greater than a threshold value.

That is, the characteristic comparator 120 may select only valid defect images from among the defect images generated through the defect generator 110.

The defect detector 130 may train the defect detection model 30 based on valid defect images selected through the characteristic comparator 120.

The characteristic comparator 120 may determine a validity when the above defect image is generated but may be considered normal because the defect is not properly generated, when a defect is generated only in a local area among the areas where generation is desired, or when a defect is generated at a location that is significantly different from the original image. That is, the valid defect images may be selected from among the generated defect images.

In addition, the defect detector 130 may detect the defect area and detect the valid defect area among the detected defect areas through the characteristic comparator 120.

The valid defect area includes the defect area DA that was generated based on the defect information 21, excluding defect areas that may be considered normal among the defect areas.

That is, the defect detector 130 may also evaluate defects through the characteristic comparator 120 and may be guided to locate the defect area where local defects are generated.

For example, the characteristic comparator 120 selects valid defective areas using a threshold value. The constants that include the threshold value allow areas that are sufficiently large to be considered normal to be ignored, while the quantiles reflected in the threshold value allow local areas by focusing on relative defect areas to be found.

In an example, the generated defect image may pass through both the SOTA model MD1 and the normal concentration model MD2 to obtain two feature vectors, and the characteristic comparator 120 may infer how different each area is from the normal by the square of the difference between the two feature vectors.

In the normal part, the two feature vectors must have the same values, and in the generated local area, the feature vectors must have different values to detect a specific defect. The characteristic comparator 120 may search for areas with significant differences based on the differences between feature vectors.

Through the above process, the defect detector 130 may learn a model so that the difference in the values of the two feature vectors increases only in areas with significant differences—i.e., defect areas.

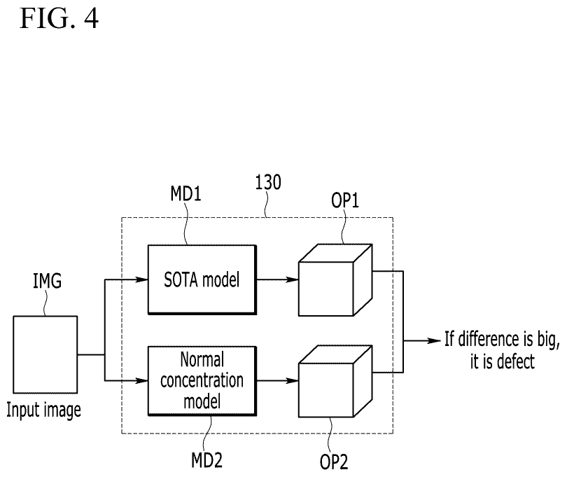

FIG. 4 illustrates an example process with defect detection of local defects device based on defect information according to one or more embodiments.

Referring to FIG. 4, in a non-limiting example, an electronic device with defect detection of local defects device based on defect information (e.g., electronic device 100) may detect defects in an input image IMG through the defect detector 130.

The defect detector 130 may include a defect detection model trained based on defect images reflecting defect information. The defect detection model may be trained to produce different outputs from the normal concentration model MD2 to the SOTA model MD1 for defect areas including pre-learned local defects through defect images based on defect information. More specifically, the electronic device may detect defects in the input image IMG using the defect detection model generated by the defect detector 130.

In an example, an image IMG is input to both the SOTA model MD1 and the normal concentration model MD2, and an electronic device (e.g., electronic device 100) may detect a defect when the difference between the first output OP1 and the second output OP2 is greater than a predetermined amount.

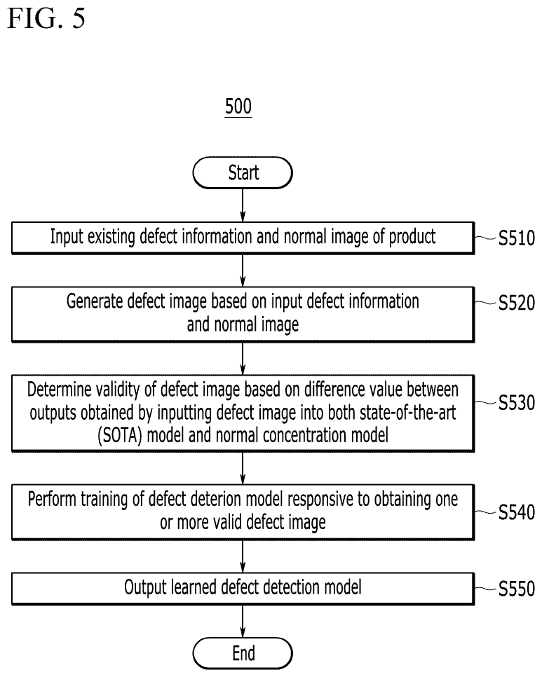

FIG. 5 illustrates an example method with defect detection of local defects device based on defect information according to one or more embodiments.

Referring to FIG. 5, in a non-limiting example, an electronic device (e.g., electronic device 100) may perform a method 500 with detection of local defects based on defect information in which existing defect information and a normal image of a product may be received or input in step S510.

In an example, an electronic device with defect detection of local defects device based on defect information (e.g., electronic device 100) may generate defect images based on input defect information and a normal image in step S520. The defect images may be generated using at least one of a generative artificial intelligence model and an image processing library.

The local defects may be generated to reflect the defect information at a specific location of a normal image. A defect area may be defined as an area including a local defect to generate a defect image which includes the defect area.

In addition, a validity for the generated defect area and the defect image including the defect area may be determined based on whether the defect information is reflected and whether there is enough specificity for it to be determined as a local defect.

In an example, the electronic device (e.g., electronic device 100) may determine the validity of the defect image based on the difference value between the outputs obtained by inputting the defect image into both the SOTA model and the normal concentration model in step S530.

A defect image including a valid defect area may be determined based on the difference value being greater than a threshold value.

In an example, the validity may be determined based on a loss function. The loss function may be calculated where loss function causes the difference value to appear greater than the threshold value only in the valid defect area and the difference value to appear as 0 in the remaining areas.

In an example, the generated defect image may be input into both the SOTA model and the normal concentration model to calculate a first feature vector and the second feature vector. Accordingly, a defect area may be detected in a defect image based on the difference between the first feature vector and the second feature vector.

For example, a different between a defect area and a normal area may be calculated according to a square of the difference between the first feature vector and the second feature vector using the following Equation 1.

$$dist = {‖ \text{?} ( \tilde{𝕀} ) - {f}_{AD} ( \tilde{𝕀} ) ‖}^{2} \qquad Equation 1$$

$$\text{?} \text{indicates text missing or illegible when filed}$$

Here, dist refers to the difference value between the two feature vectors, f_prior refers to the first feature vector of the SOTA model, f_AD refers to the second feature vector of the normal concentration model, and [symbol] refers to a defect image with a local defect.

In the normal part, the feature vectors should have the same values, and in the generated defect area, the feature vectors may have different values to enhance the detection of specific defects. That is, a defect area that includes a local defect may be detected by searching an area that has a large difference between the feature vectors. For example, a defect area may be detected using Equation 2.

$$max \text{?} ( dist ) \qquad Equation 2$$

$$\text{?} \text{indicates text missing or illegible when filed}$$

Here, _{Th} may refer to a threshold value, and max may refer to a function that finds a value greater than _{Th}. The threshold _{Th} is a number defined by a specific quantile and a constant, and the max function may be a function that returns 0 for values less than _{Th}.

For example, the threshold value may be calculated as in Equation 3.

$$Th = max ( {Q}_{0.99} ( dist ) , 0.1 ) \qquad Equation 3$$

Here, Qn refers to a quantile, and when n is 0.99 as in Equation 3, it may refer to the top 1% values.

From Equations 1 to 3, a loss function that increases the difference in values of two feature vectors only for defect areas may be assigned.

Here, the constant reflected in the threshold value allows areas that are sufficiently large to be considered normal to be ignored. The quantile reflected in the threshold value allows the local area to be found by focusing on the relative defect areas.

In an example, the electronic device (e.g., the electronic device 100) may perform training of a defect detection model responsive to obtaining one or more valid defect images in step S540. That is, the defect detection model may be trained with valid defect images. For example, defect images of a particular type of semiconductor device may be validated and then used to train a defect detection model for use in analyzing those types of semiconductor devices. The defect detection model may be trained so that the SOTA model and the normal concentration model output different values for the defect area. The SOTA model (i.e., the first model) may output a first value upon analyzing an area of the subject image (i.e., an area being considered) and the normal concentration model output (i.e., the second model) may output a second value upon analyzing that same area. The first value and the second value may be the same when the area being considered is a normal, non-defective area. The first value and the second area may be different values when the area being considered is a defect area (i.e., a local defect).

In an example, the electronic device (e.g., the electronic device 100) may output the trained defect detection model in step S550. For example, a user such as a manufacturer may receive the trained defect detection model to be employed at a manufacturing plant. The trained model may be trained for product or products being produced at the manufacturing plant in relatively short periods of time as new products are being designed. That is, examples of the electronic device may provide end users with custom models as new updates of products are designed.

The input image may be detected as a local defect when the first output value through the first model and the second output value through the normal concentration model differ from each other by a certain standard or more by the defect detection model.

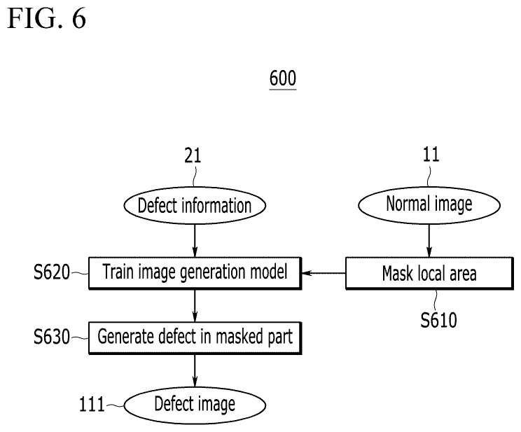

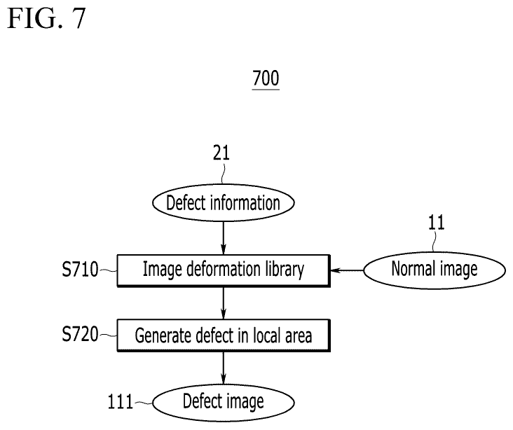

FIGS. 6 and 7 illustrate example methods with defect image generation according to one or more embodiments.

A method for generating a defect may include using a generative deep learning model, and using an image deformation library (e.g., Python-based) based on information from experts.

Referring to FIG. 6, in a non-limiting example, an electronic device (e.g., electronic device 100) may perform a method 600 with generating a defect image using an image generation model. In an example, the electronic device (e.g., the electronic device The local defect detection device based on defect information 100) may mask a local area in the normal image 11 of a product in step S610. The local area may be an area for which a local defect is to be generated.

In an example, the electronic device (e.g., the electronic device 100) may train the image generation model based on the defect information 21 and a masked local area in step S620. The image generation model includes, but is not particularly limited to, a large language model (LLM) or a diffuser model trained to create or generate images from prompts and descriptions of defects from the defect information. In an example, the image generation model may be provided with images of defects from the defect information 21. For example, the image generation model may be given instructions to create a defect in a normal image of a product based on either one of a description of a defect to be added or by adding an image of a defect to the normal image.

In an example, the electronic device (e.g., the electronic device 100) may generate a defect in a masked part using a trained image generation model in step S630. The image including the generated defect may be defined as the defect image 111.

Referring to FIG. 7, in a non-limiting example, an electronic device (e.g., electronic device 100) may perform a method 700 with generating a defect image by the image deformation library.

In an example, an electronic device (e.g., electronic device 100) may input the normal image 11 and the defect information 21 into the image deformation library in step S710. The image deformation library is not specifically limited to using image deformation or image processing techniques.

In an example, the electronic device (e.g., the electronic device The local defect detection device based on defect information 100) may generate a defect in a local area using image processing tools by inserting an image of a defect obtained from the deformation image library in step S720. The defect detection model may be trained using the defect image 111 including the generated defect, and detect a defect in the input image by the defect detection model.

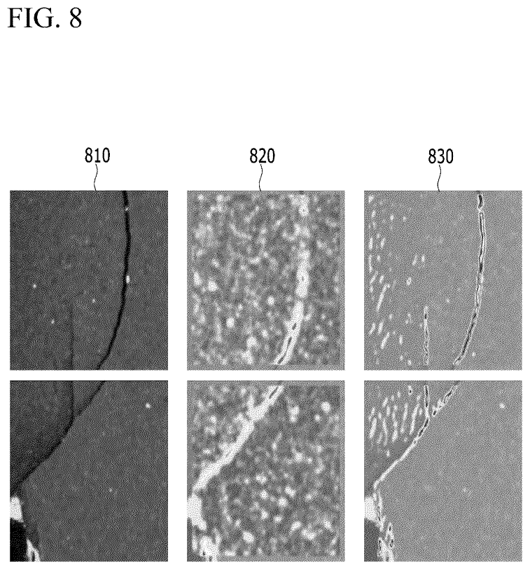

FIG. 8 illustrates an example effect according to one or more embodiments.

Referring to FIG. 8, in a non-limiting example, the detection effect for micro-cracks found as defects in an input image 810 is illustrated.

When using the existing SOTA model, result 820 illustrates that not all defects in the input image 810 are detected.

On the other hand, in image 830 it is illustrated that all micro-cracks in the input image 810 may be detected using the defect detection model.

FIG. 9 illustrates an example electronic device according to one or more embodiments.

Referring to FIG. 9, in a non-limiting example, an electronic apparatus (e.g., electronic device 100) and method (e.g., method 500) with detection of local defects may be implemented using an electronic apparatus 900.

The electronic apparatus 900 may include at least one of the processor 910, the memory 930, a user interface input device 940, a user interface output device 950, and a storage device 560 communicating through a bus 920. The electronic apparatus 900 may also include a network interface 970 electrically connected to a network 90. The network interface 970 may transmit or receive signals to or from other entities through the network 90.

The processor 910 may be configured to execute programs or applications to configure the processor 910 to control the electronic device 50 to perform one or more or all operations and/or methods involving providing of positional encoding to a neural network. The processor 910 may be implemented as various types of computing devices, such as a microcontroller unit (MCU), an application processor (AP), a central processing unit (CPU), a graphic processing unit (GPU), a neural processing unit (NPU), etc., and may be any semiconductor device that executes instructions stored in the memory 930 or a storage device 960. The processor 910 may be configured to implement various functions and methods described above with respect to FIGS. 1 to 8.

The memory 930 may include computer-readable instructions. The processor 910 may be configured to execute computer-readable instructions, such as those stored in the memory 930, and through execution of the computer-readable instructions, the processor 910 may be configured to perform one or more, or any combination, of the operations and/or methods described herein. The memory 930 and the storage device 960 may include various forms of volatile or non-volatile storage media. For example, the memory may include a read-only memory (ROM) 931 and a random-access memory (RAM) 932. In an example, the memory 930 may be disposed inside or outside the processor 910, and the memory 930 may be connected to the processor 910 through various means already known in the art.

In an example, at least some of the components or functions of a device with detection of local defects that is based on defect information and methods thereof may be implemented as a program or software executed on the electronic apparatus 900, and the program or software may be stored on a computer-readable medium.

In an example, at least some of the components or functions of devices and methods with local defect detection that is based on defect information according to the embodiments may be implemented using hardware or a circuit of the electronic apparatus 900, or may be implemented as separate hardware or a circuit that can be electrically connected to the electronic apparatus 900.

The electronic devices and apparatuses, processors, memories, neural networks, detection system for detecting local defects based on defect information 1, electronic device with defect detection of local defects 100, defect generator 110, characteristic comparator 120, defect detector 130, electronic device 90, processor 910, a memory 930, user interface input device 940, user interface output device 950, storage device 960, and network interface 970 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-9 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device, comprising:
defect generating circuitry configured to generate a defect image based on defect information and a normal image;
characteristic comparison circuitry configured to determine a validity of the defect image based on a difference value between outputs obtained by inputting the defect image into a first model trained to output a first value and a second model trained to output a second value, the second value being a same value as the first value responsive to the defect image being analyzed as the normal image; and
defect detecting circuitry configured to train a defect detection model to detect defects in a subject image based on the defect image.

2. The device of claim 1, wherein the defect detecting circuitry is further configured to output a trained defect detection model based on training the model on one or more valid defect images.

3. The device of claim 1, wherein the defect generating circuitry is further configured to:
generate a local defect reflecting the defect information at a specific location based on the normal image;
define an area of the defect image including the local defect as a defect area; and
generate the defect image to include the defect area.

4. The device of claim 3, wherein the characteristic comparison circuitry is further configured to determine that the defect image includes a valid defect area responsive to the difference value being greater than a threshold value.

5. The device of claim 4, wherein the characteristic comparison circuitry is configured to:
calculate a loss function to cause the difference value to appear greater than the threshold value in the valid defect area; and
calculate the difference value to appear as 0 in remaining areas other than the valid defect area, and
wherein the characteristic comparison circuitry determine the validity using the loss function.

6. The device of claim 5, wherein the defect generating circuitry is configured to train the defect detection model for the first model and the second model to respectively output the first value and the second value as different values responsive to detecting an area of the defect image containing the defect area.

7. The device of claim 1, wherein a trained defect detection model from the defect detecting circuitry is trained to determine the subject image as containing a defect responsive to a difference value between the first value and the second value being greater than a predetermined value.

8. An electronic device, comprising:
one or more processors comprising processing circuitry; and
a memory comprising one or more storage media storing instructions that, when executed individually or collectively by the one or more processors, cause the electronic device to: generate a defect image based on defect information and a normal image;
determine a validity of the defect image based on a difference value between outputs obtained by inputting the defect image into a first model trained to output a first value and a second model trained to output a second value, the second value being a same value as the first value responsive to the defect image being analyzed as the normal image; and
train a defect detection model to detect defects in a subject image based on one or more valid defect images to provide a trained defect detection model.

9. The device of claim 8, wherein the generating comprises:
instructing an image generation model to create the defect image using defect information to create a local defect in the normal image.

10. The device of claim 8, wherein the generating further comprises:
using an image processing device to modify the normal image with an image of a defect from a deformation image library at a localized region in the normal image.

11. The device of claim 8, wherein the generating of the defect image comprises:
generating a local defect reflecting the defect information at a localized region based on the normal image;
defining an area of the defect image including the local defect as a defect area; and
generating the defect image to include the defect area.

12. The device of claim 11, wherein the determining further comprises:
calculating a loss function to cause the difference value to appear greater than a threshold value in the valid defect area;
calculating the difference value to appear as 0 in remaining areas other than the valid defect area; and
determining the validity based on the loss function.

13. The device of claim 12, wherein the training further comprises:
training the defect detection model for the first model and the second model to respectively output the first value and the second value as different values responsive to detecting an area of the defect image containing the defect area.

14. A processor-implemented method, comprising:
generating a defect image based on defect information and a normal image;
determining a validity of the defect image based on a difference value between outputs obtained by inputting the defect image into a first model trained to output a first value and a second model trained to output a second value, the second value being a same value as the first value responsive to the defect image being analyzed as the normal image; and
training a defect detection model to detect defects in a subject image based on the defect image.

15. The method of claim 14, further comprising:
providing a trained defect detection model based on training the model on one or more valid defect images.

16. The method of claim 14, wherein the generating comprises:
generating a local defect reflecting the defect information at a specific location based on the normal image;
defining an area of the defect image including the local defect as a defect area; and
generating the defect image to include the defect area.

17. The method of claim 16, wherein the determining further comprises:
determining that the defect image includes a valid defect area responsive to the difference value being greater than a threshold value.

18. The method of claim 17, wherein the determining further comprises:
calculating a loss function to cause the difference value to appear greater than the threshold value in the valid defect area;
calculating the difference value to appear as 0 in remaining areas other than the valid defect area; and
determining the validity based on the loss function.

19. The method of claim 18, wherein the training further comprises:
training the defect detection model for the first model and the second model to respectively output the first value and the second value as different values responsive to detecting an area of the defect image containing the defect area.

20. The method of claim 14, wherein a trained defect detection model from the training is trained to determine whether the subject image contains a defect responsive to a difference value between the first value and the second value being greater than a predetermined value.
